(19) United States
(12) Patent Application Publication
(10) Pub. No.: US 2013/0254006 A1
(43) Pub. Date: Sep. 26, 2013

(54) APPARATUS AND METHOD FOR TRANSFERRING COMMERCIAL DATA AT A STORE

(71) Applicants: Dalit BRAUN, Tel Aviv (IL); Asaf LEWIN, Nordiya (IL)

(72) Inventors: Dalit BRAUN, Tel Aviv (IL); Asaf LEWIN, Nordiya (IL)

(73) Assignee: PICK'NTELL LTD., Tel Aviv (IL)

(21) Appl. No.: 13/424,392

(22) Filed: Mar. 20, 2012

(51) Int. Cl. G06Q 30/00; G06Q 30/02

(52) U.S. Cl. 705/14.25; 705/26.7

(57) ABSTRACT

The subject matter discloses a method, comprising identifying a customer in a retail store; obtaining personal data related to the customer; obtaining commercial data related to the customer; transmitting a message comprising the personal data and the commercial data to a computerized device accessible to an employee of the retail store; wherein the method is performed by a processor. In some cases, the method further comprises obtaining try-on data related to the customer and transmitting the try-on data related to the customer to the computerized device accessible to the employee of the retail store. In some cases, the method further comprises a step of recommending an article to be suggested to the customer based on the commercial data and adding data related to the article to be suggested to the message transmitted to the computerized device accessible to the employee of the retail store.

### FIELD OF THE INVENTION

The subject matter relates generally to retail clothing and more specifically to a method for transmitting data concerning a client at a retail store.

### BACKGROUND OF THE INVENTION

Retail stores try to increase sales and profits in various ways. Such ways include sales, coupons, advertisements and others. Retail stores spend many resources on focused advertisement or personalized approach to customers. Such personalized approach provides specific data to the customer according to known parameters, such as gender, age, address, previous purchases and the like. The personalized approach is provided using SMS messages, email messages to the customer's email address or the customer's mobile device. Retail stores also try to increase sales using loyalty clubs, credit cards specific to a retail store or a group of retail stores and the like.

However, when the customer enters the retail store, the store is “blind” and obtains no information on the customer unless he/she voluntarily show the loyalty card, uses a credit card at the cashier or provide other details to the seller.

### SUMMARY

It is an object of the subject matter to disclose a method, comprising identifying a customer in a retail store; obtaining personal data related to the customer; obtaining commercial data related to the customer; transmitting a message comprising the personal data and the commercial data to a computerized device accessible to an employee of the retail store; wherein the method is performed by a processor.

In some cases, the method further comprises obtaining try-on data related to the customer and transmitting the try-on data related to the customer to the computerized device accessible to the employee of the retail store.

In some cases, the method further comprises a step of recommending an article to be suggested to the customer based on the commercial data and adding data related to the article to be suggested to the message transmitted to the computerized device accessible to the employee of the retail store.

In some cases, the commercial data comprises data obtained from mirror points in which the customer tried an article. In some cases, the method further comprises a step of scanning a barcode associated by the article. In some cases, the method further comprises determining a recommendation based on the article.

In some cases, the method further comprises a step of transmitting an image of the customer to the computerized device accessible to the employee of the retail store.

In some cases, the method further comprises a step of visually marking the commercial data according to predefined parameters.

In some cases, the employee's computerized device is selected from two or more employee's computerized devices, each of the two or more computerized devices at the retail store, wherein the method further comprises a step of determining a computerized device.

In some cases, the method further comprises enabling the customer to initiate a message to the employee's computerized device while the customer is in the retail store.

In some cases, after receiving the message and obtaining information that the customer is in the retail store, the employee's computerized device transmits a message that comprises coupon to the customer's computerized device while the customer is in the retail store.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows a computerized environment associated with a clothing store, according to some exemplary embodiments of the subject matter;

FIG. 2 shows a personalization messaging system associated with a retail store, according to some exemplary embodiments of the subject matter;

FIG. 3 shows a message received at an employee's computerized device at a retail store, according to some exemplary embodiments of the subject matter;

FIG. 4 shows a method of handling personalized messaging at a retail store, according to some exemplary embodiments of the subject matter; and,

FIG. 5 shows a mirror point system used at a personalization messaging system at a retail store, according to some exemplary embodiments of the subject matter.

### DETAILED DESCRIPTION

One technical challenge disclosed in the subject matter is the unawareness of a retail store employee of any information related to a customer that enters the retail store. Hence, the retail store employee is unable to offer an article to the customer.

One technical solution of the disclosed subject matter is a computerized system that identifies the presence of the customer at the retail store and transmits a message concerning the customer to a computerized device accessible by the retail store employee. Identifying the customer may be performed after the customer logs in to a mobile application that communicates with the computerized system. The customer willfully identifies before the retail store using the mobile application or using a mirror point system in the retail store, or the customer scans a barcode. The computerized system may include commercial data at the message to the employee's computerized device.

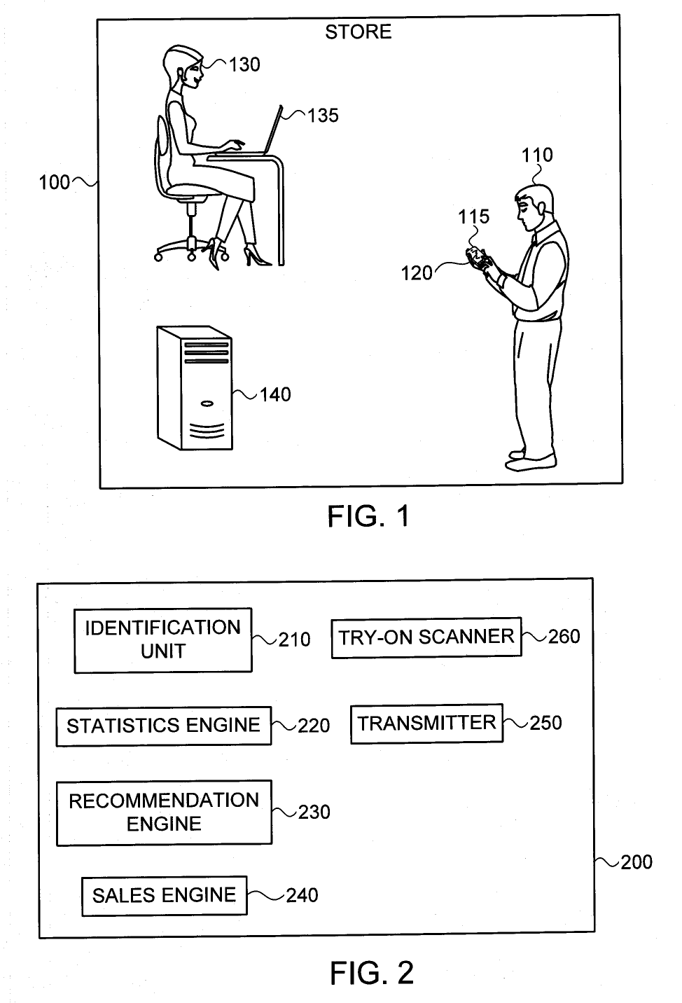

FIG. 1 shows a computerized environment associated with a retail store, according to some exemplary embodiments of the subject matter. The computerized environment includes a retail store 100 to which a customer 110 enters in order to review and purchase goods. The retail store may be of apparel goods, such as clothing or shoes. The retail store 100 may relate to other goods, such as furniture, electronics, appliances, Do it yourself products, life style products, perfumes and the like. According to the system and method of the subject matter, the customer 110 carries a computerized device 120, such as a mobile phone, Tablet computer, iPod, Laptop computer or any other computerized device with a display that is connectable to a communication network. The customer 110 uses the computerized device 120 to communicate with the retail store 100, or to communicate with another entity that communicates with the retail store, such as a loyalty club that has a mobile application 115 running on the computerized device. When the customer 110 enters or uses the mobile application 115 or a predefined web page, an employee 130 of the retail store 100 is notified.

The employee 130 may be a seller, cashier, a manager or have any other position in the retail store 100. The employee uses an employee computerized device 135. The employee's computerized device 135 may be stationary, for example the cash register computer, or a mobile device such as a mobile phone or a Tablet computer. When the customer 110 is at the retail store 100, the customer is detected, as detailed below, by a personalization messaging system 140. The personalization messaging system 140 transmits a message to the employee's computerized device 135 concerning the detection of the customer 110 at the retail store 100.

Detection of the customer 110 at the retail store 100 may be performed in several ways. In some cases, detection of the customer 110 is performed when the customer 110 tries on an article or when customer indicated through the mobile application 115 regarding his presence in the location, or otherwise scans the article barcode on the customer's computerized device 120. In such case, a computer program, such as the mobile application 115, detects the barcode, associates the barcode with the retail store 100 and transmits a message to the employee's computerized device 135. Association of the barcode with the retail store 100 may be performed by comparing the barcode with a database of barcodes stored at the mobile application 115, stored at the personalization messaging system 140 or stored on a website accessed by the customer's computerized device 120 automatically after scanning a barcode.

In some cases, the customer 110 is detected when using a mirror point system. Such mirror point system includes a mirror used by the customer 110 to view herself when trying on an article. The mirror point system communicates with the employee's computerized device 135 and notifies using a messaging server that the customer 110 is trying on an article at the retail store associated with the mirror point system. The customer 110 may log at mirror point system in many ways, for example by entering a pin code, scanning an RFID card, or using other radio frequency technologies such as Near Field Communication (NFC), Bluetooth and the like.

In other cases, the customer 110 is detected to be at the retail store using geographical data. The customer's computerized device 120 receives geographical data, for example using a GPS receiver or from the mobile network carrier and compares the received geographical data with geographical data associated to the retail store 100 or mirror point system through a server end, the customer's computerized device 120 communicates with the employee's computerized device 135 and notifies through the server end that the customer 110 is in the retail store 100.

FIG. 2 shows a personalization messaging system associated with a retail store or group of retail stores, according to some exemplary embodiments of the subject matter. The personalization messaging system 200 comprises an identification unit 210 and a transmitter 250. The identification unit obtains data used to identify a customer. The data used to identify a customer may be obtained from the customer's computerized device 120 as discussed above. The data used to identify a customer may be obtained from a mirror point system. Such data used to identify a customer may be a phone number, credit card number, loyalty card number, data related to the customer's mobile application registration number and the like.

The transmitter may be an email server, SMS server, or another push notification or instant messaging technologies used to transmit a message to an employee's computerized device, such as 135 of FIG. 1. When the personalization messaging system 200 obtains the data used to identify the customer, the identification unit 210 uses the data to identify the customer. Identifying the customer leads to determine that the customer is at the retail store. Once the customer is determined to be at the retail store, the transmitter sends a message to the employee's computerized device 135, stating that the specific customer identified by the identification unit 210, is located at the retail store. As a result, the employee can approach the customer knowing relevant data about the customer.

In some cases, the personalization messaging system 200 comprises a statistics engine 220. The statistics engine stores various types of data items to be used when determining which messages are to be sent by the transmitter 250 to the employee's computerized device 135. The data items handles at the statistics engine 220 include the type of items he is buying, price range of items he previously bought, type and number of coupons he bought, coupons he bought but didn't redeem, statistics about questionnaires he answered, statistics about information from the customer's chats, social networks and the like. For example, the statistics engine 220 may inform the retails store employee that the customer bought 10 items of the retail store last year, all in one visit. The statistics engine 220 may provide that the customer rejected all coupons previously suggested to him, the customer prefers the color red, or that he prefers to buy clothing for children.

In some cases, the personalization messaging system 200 comprises a recommendation engine 230. The recommendation engine 230 obtains personal data of the customer and data from the statistics engine 220. The recommendation engine 230 outputs recommendations of one or more articles to be offered to the customer after identifying that the customer is at the retail store. Such recommendations may be to offer ties to the customer, as the statistics engine 220 provided that the customer has recently purchased two suits. Another example of a recommendation may be offering peripheral computerized equipment, or gadgets, in case it is known to the personalization messaging system 200 that the customer has recently purchased a Personal Computer.

In some cases, the personalization messaging system 200 comprises a try-on scanner 260. The try-on scanner 260 obtains information from a scanner at the retail store, or from a mirror point system at the retail store. In some other cases, the personalization messaging system 200 comprises a barcode scanner that enables the customer to identify at the retail store. In many cases, the customer tries on an article, to such as a T-shirt. The customer may try the T-shirt in front of a mirror to view herself wearing the T-shirt. The customer may also scan the T-shirt barcode at the customer's computerized device, such that the mobile application at the computerized device sends a message to the employee's computerized device, that the customer just tried the T-shirt. Alternatively, the customer may identify himself in front of the mirror point system, for example at a dressing room, the mirror point system comprises a camera and the image or video taken by the camera or by the customer's device is transmitted to the employee's computerized device.

In some cases, the personalization messaging system 200 comprises sales engine 240. The sales engine 240 obtains data relevant to various sales offered by the retail store. The sales engine 240 also obtains information on the customer, such as personal information, name, age and gender. The sales engine 240 may also obtain commercial information from the statistics engine 220, such as previous purchases. The sales engine 240 determines one or more sales to be transmitted to the employee according to the personal data. The determined one or more sales may also be a function of the commercial information from the statistics engine 220.

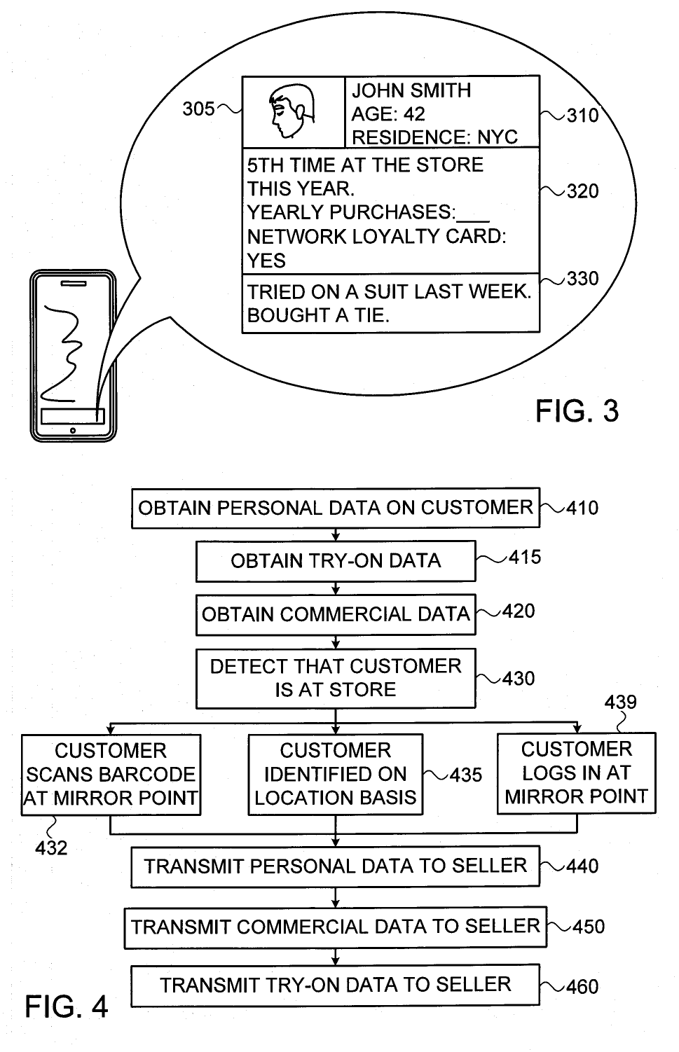

FIG. 3 shows a message received at an employee's computerized device at a retail store, according to some exemplary embodiments of the subject matter. The employee's computerized device may be a mobile phone, a Personal computer (PC), a cash register and the like. The employee's computerized device comprises a display device 300 on which a personalized message received from the personalized messaging system is displayed. The personalized message comprises personal data 310 on the customer detected to be at the retail store. The personal data comprises at least one of a list comprising the customer's name, age, place of residence, occupation, marital status and the like. The personalized message may also comprise one or more images 305 of the customer. The customer may input an image when signing up to the mobile application communicating with the personalized messaging system. The images 305 may be of the customer trying on an article, in case the personalized message is provided when the customer uses a mirror point system.

The personalized message may also comprise commercial data 320 related to the customer detected to be at the retail store. The commercial data comprises at least one of a list comprising the details and number of purchases the customer performed on the retail store during the previous 12 months, the number and percentage of coupons the customer used, a list of items he purchased, segmentation of those items and the like. In some exemplary cases, the commercial data 320 of the customer may be marked by a marking module (not shown) the personalized messaging system. For example, in case the customer has never purchased an item in the retail store, the marking module provides a yellow background to the commercial data 320 of the personalized message displayed on the display device 300. The marking module may also determine font size, language, an image of an item the customer previously purchased and the like.

The personalized message may also comprise try-on data 330. The try-on data may be provided using data received from the mirror point system at the retail store or using data received from the customer's computerized device. The try-on data 330 comprises a list of articles the customer detected to be at the retail store tried. For example, the try-on data 330 may be “tried on a suit last week” or “tried on elegant shoes 5 minutes ago”. The list of articles may relate to the current visit of the customer at the retail store or to previous visits to this store or other stores of this retail chain or brand. When the customer tries on an article, he/she may use a mobile application to take a picture or video of himself or herself wearing the article and organize that image, share it and the like. The image with the customer trying on an article may then be transmitted from the customer's computerized device to the personalized messaging system and from the personalized messaging system to the employee's computerized device. The personalized messaging system may also obtain data associated with catalog items that the customer has viewed and or chatted about, for example in a social network. The image in which the customer tries on an article may be transmitted from a mirror point system to the employees' computerized device, even if the employee is not signed in to a mobile application communicating with the personalized messaging system. In some cases, the employee must sign in into the mobile application in the employee's computerized device in order to receive the message from the customer.

FIG. 4 shows a method of handling personalized messaging at a retail store, according to some exemplary embodiments of the subject matter. It should be noted that the steps that refer to obtaining information on the customer may be performed before identifying that the customer is at the retail store. The personalized messaging system of the subject matter may update records associated with such data after the customer is identified to be at the store.

In step 410, the subject matter discloses obtaining personal data of the customer detected to be at a retail store. Such personal data may be the customer's age, place of residence, preferred language, self picture, known preferences, wish lists and the like. Such personal data may be provided using a mobile device used by the customer at the retail store. In some cases, the customer's computerized device is identified by the personalized messaging system, for example using a cellular IP address associated with a cellular number. The number is associated with the customer, so the personalized messaging system knows that the customer is at the retail store. In some exemplary cases, a mobile application that operates on the customer's computerized device obtains the personal data and identifies the retail store according to the location of the retail store that is stored at the mobile application and compared to the location received at a GPS receiver of the customer's computerized device or from location information available from the mobile network carrier.

In step 415, the subject matter discloses obtaining try-on data of the customer detected to be at a retail store. In some cases, the try-on data of the customer comprises previous try-ons, barcode scans and self pictures associated to the customer within a brand associated with the retail store. The try-on data of the customer may also include information from his/her social networks and friends regarding their feedback on his/her try-ons.

In step 420, the subject matter discloses obtaining commercial data of the customer detected to be at a retail store. In some cases, the personalized messaging stores the commercial data of many customers. In other cases, the commercial data is stored at the customer's computerized device and transmitted to the personalized messaging system upon detection that the customer is at the retail store. The commercial data may comprise customer's personal profile, try on history, demographics, store visit history, previous coupons usage, previous interactions with sellers, response to previous recommendations and the like. The personalized messaging system may then determine the commercial message to he transmitted to the employee's computerized device. The commercial message may include a recommended action for the employee such as approach (or do not approach) the customer, send a coupon to the customer, recommend an accessory or additional garment article to the customer (based on the recommendation engine) and the like.

In step 430, the subject matter discloses identifying the customer at the retail store. The identification may also include a step of determining the state of the customer, the customer's willingness to receive assistance, recommendations or promotions and the like. The step may include detecting the presence of the customer at the retail store. Such detection may be performed in several manners. In step 432, the detection is performed after the customer scans a barcode at a mirror point system and the mirror point transmits the image and information related to the barcode to the personalized messaging system. The barcode scan may be scanned at the cashier, on a garment article, or anywhere in the retail store. The term barcode also refers to a QR code. When the barcode scan is identified by the personalized messaging system, the system obtaining try-on data on the customer. Alternatively, the customer's computerized device transmits the image taken by a camera of the customer's computerized device in front of the mirror point system. In step 435, the customer is identified on a location basis, for example by comparing GPS data customer's computerized device with the location data of the retail store stored at the customer's computerized device. In step 439, the customer logs in to a mirror point system at the retail store. The customer may log at mirror point in many ways, such as by entering a pin code, scanning an RFID card, or using other radio frequency technologies such as NFC, or Bluetooth. The mirror point system then transmits a message to the personalized messaging system that the customer is at the retail store. The customer's identification may be performed after the customer indicates her presence in the store, for example using a mobile application.

In step 440, the personalized messaging system transmits a message comprising personal data to the employee's computerized device. The personal data may comprise the customer's name, age, place of residence, preferred language, number and dates of last visits at the store and the like.

In step 450, the personalized messaging system transmits a message comprising commercial data to the employee's computerized device. The commercial data may comprise previous purchases of the customer, whether she is a member in the retail store's loyalty club, previous purchases of coupons, date of last visit, date of last purchase and the like. The commercial data may also comprise a recommended action to the employee, such as approach (or do not approach) the customer, send a coupon to the customer, recommend an accessory or additional garment article to the customer and the like.

In step 460, the personalized messaging system transmits a message comprising try-on data to the employee's computerized device. The try-on data may comprise data related to articles the customer has recently tried. Such article may be a shoe, shirt, skirt, hat and the like. The try-on data may be an image of the customer wearing the article, or the last location of the customer in the retails store (e.g. in the men's department on the 4^{th} floor). The try-on data may be transmitted to the personalized messaging system from the mirror point system or from the customer's computerized device. In some cases, the mirror point system transmits images of every customer that tries on an article to the employee's computerized device using the server. In some exemplary cases, the employee's computerized device to which the message is transmitted from the personalized messaging system is selected from two or more employee's computerized devices located at the retail store. In such a case, the method further comprises a step of determining an employee's computerized device such as taking into consideration the department in which the employee is currently serving, clothing category in which the employee is responsible of, and information such as the availability of the employee at the current time, or previous interactions of the employee with the customer. The try-on data is limited to the brand associated with the retail store, and improves the employee's understanding of the style, color, and fit category preferences of the customer while in the retail store.

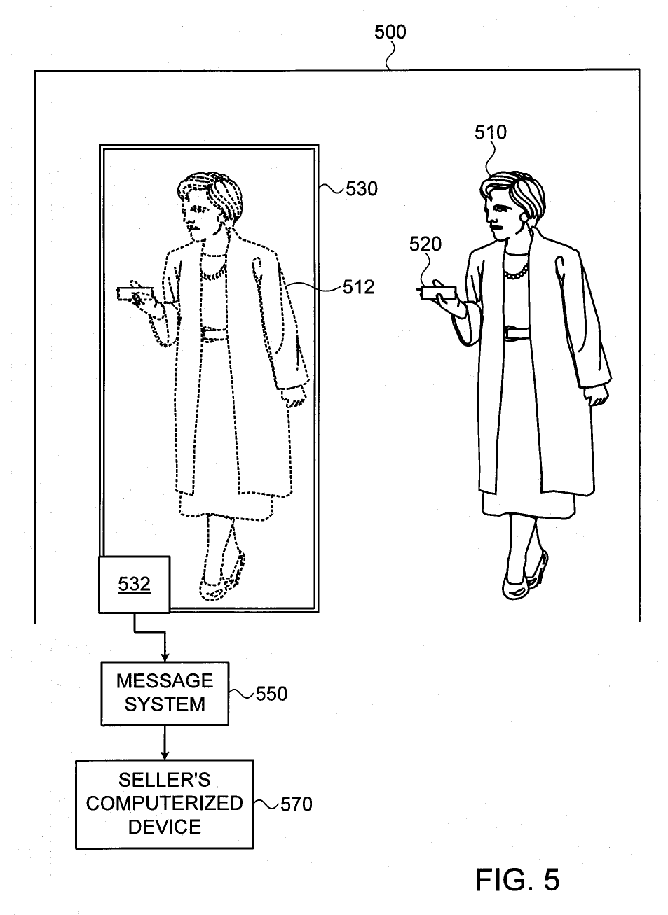

FIG. 5 shows a mirror point system used at a personalization messaging system at a retail store, according to some exemplary embodiments of the subject matter. The mirror point system may reside near a dressing room 500 at the retail store. The customer 510 stands in front of the mirror 530 and controls the mirror point system using the customer's computerized device 520. The customer 510 determines when to take a picture of him or a customer's reflection 512 using the customer's computerized device 520. When a picture is taken by the customer's computerized device 520 or by a camera 532 at the mirror point system, the picture may be transmitted to the employee's computerized device 570. In some cases, the picture is transmitted only after identifying the customer after the customer scans a barcode or identified using a mobile application operating on the customer's computerized device 520. The picture and try-on data, for example the barcode of an article worn by the customer when taking the picture, are sent to a personalized messaging system 550 that transmits the picture and preferably try-on data to the employee's computerized device 570.

In some exemplary cases, the personalized messaging system of the disclosed subject matter enables the customer to initiate a message to the employee's computerized device while the customer is in the retail store. The customer may initiate such message in case she needs assistance from the retail store employee. The customer may also send an alert message to the retail store employee while the customer is in the retail store using the customer's computerized device.

In some exemplary cases, the subject matter enables the retail store employee to send a message that comprises coupon to the customer's computerized device while the customer is in the retail store. The message may comprise another type of message (such as “I will be with you shortly”). When the customer is identified to be at the retail store, a message may be transmitted to the employee's computerized device. The personalized messaging system may suggest one or more coupons to the employee, from which one or more coupons are sent to the customer's computerized device. In some cases, the personalized messaging system determines the coupon to be sent to the customer's computerized device and only notifies the employee accordingly.

While the disclosure has been described with reference to exemplary embodiments, it will be understood by those skilled in the art that various changes may be made and equivalents may be substituted for elements thereof without departing from the scope of the subject matter. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

1. A method, comprising:
identifying a customer in a retail store;
obtaining personal data related to the customer;
obtaining commercial data related to the customer;
transmitting a message comprising the personal data and the commercial data to a computerized device accessible to an employee of the retail store;
wherein the method is performed by a processor.

2. The method according to claim 1, further comprises obtaining try-on data related to the customer and transmitting the try-on data related to the customer to the computerized device accessible to the employee of the retail store.

3. The method according to claim 1, further comprises a step of recommending an article to be suggested to the customer based on the commercial data and adding data related to the article to be suggested to the message transmitted to the computerized device accessible to the employee of the retail store.

4. The method according to claim 1, wherein the commercial data comprises data obtained from mirror points in which the customer tried an article.

5. The method according to claim 4, further comprises a step of scanning a barcode associated by the article.

6. The method according to claim 4, further comprises determining a recommendation based on the article.

7. The method according to claim 1, further comprises a step of transmitting an image of the customer to the computerized device accessible to the employee of the retail store.

8. The method according to claim 1, further comprises a step of visually marking the commercial data according to predefined parameters.

9. The method according to claim 1, wherein the computerized device is selected from two or more employee's computerized devices, each of the two or more employee's computerized devices located at the retail store, wherein the method further comprises a step of determining an employee's computerized device.

10. The method according to claim 1, further comprises enabling the customer to initiate a message to the employee's computerized device while the customer is in the retail store.

11. The method according to claim 1, wherein after receiving the message and obtaining information that the customer is in the retail store, the employee's computerized device transmits a message to the customer's computerized device while the customer is in the retail store.

12. The method according to claim 11, wherein the message to the customer's computerized device while the customer is in the retail store comprises a coupon.
